(19) United States
(12) Patent Application Publication
(10) Pub. No.: US 2011/0050646 A1
(43) Pub. Date: Mar. 3, 2011

(54) OPTICAL TOUCH APPARATUS AND OPTICAL TOUCH DISPLAY APPARATUS

(75) Inventors: Tun-Chien Teng, Hsin-Chu (TW); Chun-Chien Liao, Hsin-Chu (TW); Han-Wen Tsai, Hsin-Chu (TW); Chih-Jen Tsang, Hsin-Chu (TW)

(73) Assignee: CORETRONIC CORPORATION, Hsin-Chu (TW)

(21) Appl. No.: 12/858,434

(22) Filed: Aug. 17, 2010

(30) Foreign Application Priority Data
Aug. 28, 2009 (TW) 98129124

(51) Int. Cl. G06F 3/042

(52) U.S. Cl. 345/175

(57) ABSTRACT

An optical touch apparatus is adapted to a display apparatus. The optical touch apparatus includes at least one light source, at least one light guide unit, and at least one optical detector. The light source is disposed beside a display area of the display apparatus and capable of providing a light beam. The light guide unit is disposed beside the display area in a transmission path of the light beam and has a first surface, a second surface opposite to the first surface, and a light incident surface. The light incident surface connects the first and second surfaces. The light beam is capable of entering the light guide unit through the light incident surface and is transmitted to a sensing space in front of the display area. The optical detector is disposed beside the display area to sense an intensity variation of the light beam in the sensing space.

### CROSS-REFERENCE TO RELATED APPLICATION

This application claims the priority benefit of Taiwan application serial no. 98129124, filed on Aug. 28, 2009. The entirety of the above-mentioned patent application is hereby incorporated by reference herein and made a part of this specification.

### BACKGROUND OF THE INVENTION

1. Field of the Invention

The invention relates to a touch apparatus and a touch display apparatus, and particularly to an optical touch apparatus and an optical touch display apparatus.

2. Description of Related Art

As information technique, wireless mobile communication, and information appliances have been rapidly developed, to achieve more convenience, more compact and light volume and more user-friendly designs, various information products have changed from conventional input devices such as key boards or mice to touch panels. A touch panel may be attached to a display device to form a touch panel display device. Touch panels may be categorized into resistance touch panels, capacitance touch panels, optical touch panels, sound wave touch panels, and electromagnetic touch panels, etc, based on differences in the sensing principles.

In a resistance touch panel, a voltage drop is generated at a conductive place when two conductive layers originally separated from each other are connected together due to a single-point press. Then, a coordinate where the user presses is determined according to the position of the voltage drop. On the other hand, in a capacitance touch panel, a uniform electric field is formed between an inner conductive layer and an outer conductive layer. When a conductor (e.g. a finger of human) touches the panel, a slight variation of capacitance occurs. Hence, the coordinate of the touch position on the panel is determined according to the position of the variation of capacitance.

Furthermore, a manufacturing method relative to an optical component and several optical touch apparatuses are also provided. Taking Taiwan Patent Publication No. 200841057 as an example, it discloses a manufacturing method of a stamper. The method mainly includes following steps. First, ultra-violet (UV) light cured glue is sprayed on a substrate and cured to form a three-dimensional pattern. Thereafter, a stamper is formed on the substrate with a pattern opposite to the three-dimensional pattern. Finally, a light guide plate having a pattern the same as the three-dimensional pattern is produced by using the stamper.

Besides, Taiwan Patent Publication No. 200841227 discloses an optical touch apparatus. The optical touch apparatus mainly includes a light source, a light guide module, and an image sensing module. The light source emits light into the light guide module, and the light guide module transmits a moving state of an input device to the image sensing module. After sensing optical information generated by the light guide module, the image sensing module generates an electronic signal according to the optical information and then transmits the electronic signal to a processing circuit.

In addition, Taiwan Patent No. M359718 discloses a side type backlight module which includes a plurality of light emitting diodes (LEDs), a light guide plate, a brightness enhancement film, and a diffusion film. Each of the LEDs has a light emitting surface which faces the same direction. The light guide plate is disposed at one side of the LEDs and has a light incident surface, a light exit surface, and a bottom surface. The light incident surface faces the light emitting surfaces of the LEDs. The light exit surface is connected to one side of the light incident surface. The bottom surface of the LED is opposite to the light exit surface and connected to the other side of the light incident surface. Besides, the bottom surface has a plurality of optical microstructures and a plurality of flat areas. The flat areas have a common boundary with the light incident surface. Each of the flat areas is corresponding to the light emitting surfaces of the LEDs.

Furthermore, Taiwan Patent Publication No. 200846996 discloses a touch panel with an infrared ray source and an array of infrared ray sensors to detect objects in contact with, or close to, the touchable surface of the panel. The touch panel may be operated in both reflective and shadow modes.

U.S. Pat. No. 4,868,912 also discloses a touch panel system. The touch panel system has a plurality of light emitting elements and a plurality of light receiving elements surrounding a display area, such that a touch position corresponding to an object is determined.

Similarly, U.S. Pat. No. 6,690,363 discloses a touch screen which has a plurality of emitters and a plurality of detectors surrounding a display screen, so that a touch position corresponding to an object is determined.

However, since each of the frameworks mentioned above requires lots of light emitting devices and many sensors, the fabricating cost is unlikely to be lowered. Moreover, the numbers of light emitting devices and sensors depends on a size of a panel. Thus, the larger the display panel is, the greater the number of the light emitting devices and the sensors are required.

### SUMMARY OF THE INVENTION

The invention provides an optical touch apparatus for determining a position of a touch object in an optical manner.

The invention provides an optical touch display apparatus which determines a position of a touch object in an optical manner.

Other objects and advantages of the invention can be further illustrated by the technical features broadly embodied and described as follows.

In order to achieve one or a portion of or all of the objects or other objects, one embodiment of the invention provides an optical touch apparatus adapted to a display apparatus. The display apparatus has a display area. The optical touch apparatus includes at least one light source, at least one light guide unit, and at least one optical detector. The light source is disposed beside the display area and capable of providing a light beam. The light guide unit is disposed beside the display area in a transmission path of the light beam. The light guide unit has a first surface, a second surface, and a light incident surface. The second surface is opposite to the first surface. The light incident surface is connected with the first surface and the second surface. The light beam is capable of entering the light guide unit through the light incident surface and being transmitted to a sensing space in front of the display area through the first surface. The optical detector is disposed beside the display area to sense an intensity variation of the light beam in the sensing space.

Another embodiment of the invention further provides an optical touch display apparatus which includes the above-mentioned display apparatus and optical touch apparatus.

Based on the above, since each of the light guide units according to the embodiments of the invention provides a uniform light source, the numbers of the light sources and optical detectors disposed beside the display area are able to be reduced. Besides, the touch position of the touch object relative to the display area is able to be determined according to the intensity variation of the light beam sensed by the optical detector.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a top view of an optical touch display apparatus in an embodiment of the invention.

FIG. 2 is a schematic cross-sectional view of the optical touch display apparatus along line I-I of FIG. 1.

FIG. 3 is a perspective schematic view of the light guide unit of FIG. 1.

FIG. 4A is a top view of the light guide unit and the light source along x-direction of FIG. 3.

FIG. 4B illustrates an irradiance distribution of a light beam in a sensing space along y-direction after being emitted from the light guide unit.

FIG. 5A is a top view of a surface S6 of the light guide unit of FIG. 3.

FIG. 5B illustrates a distribution of radiant intensity versus light emitting angle when a light beam is emitted from the surface.

FIG. 6A is a top view of a surface S6 of a light guide unit in another embodiment of the invention.

FIG. 6B illustrates another distribution of radiant intensity versus light emitting angle when a light beam is emitted from the surface.

FIG. 6C is a top view of a surface S6 of a light guide unit in another embodiment of the invention.

FIG. 7A is a top view of a light guide unit and a lens along y-direction in another embodiment of the invention.

FIG. 7B illustrates a distribution of radiant intensity versus light emitting angle when a light beam passes through a light guide unit, an air gap, and a lens.

FIG. 8A is a top view of a light guide unit, a lens, and a reflective unit along y-direction in another embodiment of the invention.

FIG. 8B illustrates another distribution of radiant intensity versus light emitting angle when a light beam passes through a light guide unit, an air gap, and a lens.

FIG. 9A is a top view of a light guide unit, a reflective unit, and a front frame along y-direction in another embodiment of the invention.

FIG. 9B is a top view of a light guide unit, a reflective unit, and a front frame along y-direction in another embodiment of the invention.

### DESCRIPTION OF EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

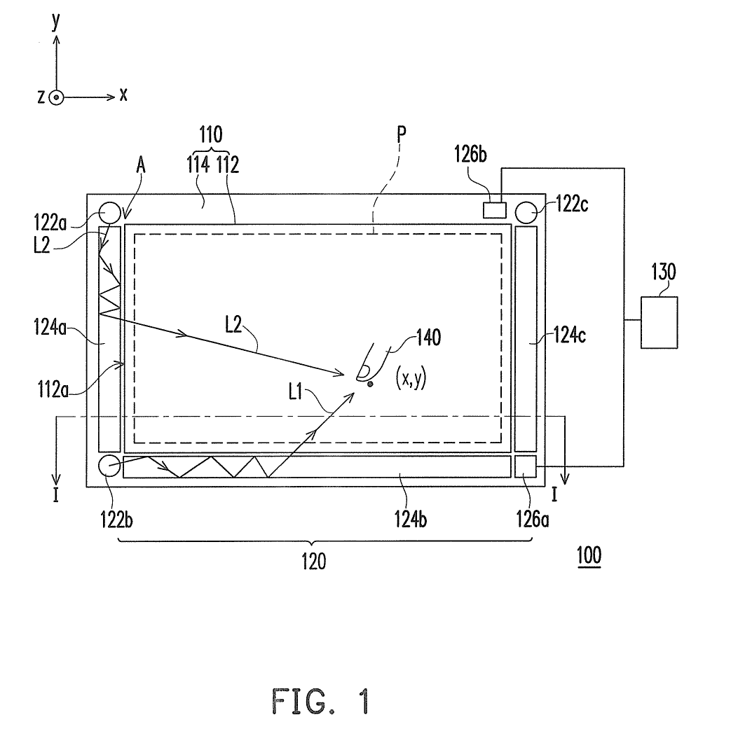

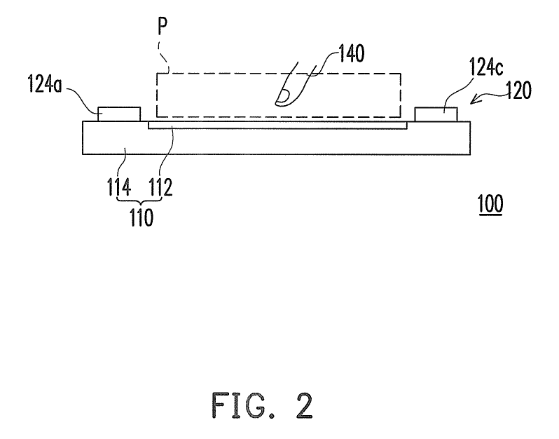

FIG. 1 is a top view of an optical touch display apparatus 100 in an embodiment of the invention. FIG. 2 is a schematic cross-sectional view of the optical touch display apparatus 100 along line I-I of FIG. 1. Referring to both FIG. 1 and FIG. 2, the optical touch display apparatus 100 includes a display apparatus 110 and an optical touch apparatus 120. The display apparatus 110 has a display area 112 and a sensing space P is in front of the display area 112. Besides, the display apparatus 110 of this embodiment further includes a front frame 114. In the embodiment, the display area 112 is disposed in the front frame 114 and the optical touch apparatus 120 is disposed on the front frame 114.

As shown in FIG. 1, the optical touch apparatus 120 includes at least one light source 122b, at least one light guide unit 124b, and at least one optical detector 126a. The light source 122b is disposed beside the display area 112 and capable of providing a light beam L1. In the embodiment, the light beam L1 is, for example, invisible light and the light source 122b is an infrared light emitting diode (IR-LED), for example.

Referring to FIG. 1, the light guide unit 124b is disposed in a transmission path of the light beam L1. On the other hand, the optical touch apparatus 120 of the embodiment includes a plurality of light sources, e.g. light sources 122a˜122c (three light sources are schematically shown in FIG. 1). The optical detector 126a is disposed beside the display area 112 to sense an intensity variation of a light beam (e.g. a light beam L2) in the sensing space P. Otherwise, the optical touch apparatus 120 further includes a plurality of light guide units and a plurality of optical detectors. For example, light guide units 124a˜124c (three light guide units are schematically shown in FIG. 1) and optical detectors 126a and 126b (two optical detectors are schematically shown in FIG. 1). The light guide units 124a˜124c and the corresponding light sources 122a˜122c are disposed at different sides of the display area 112, respectively. Each of the optical detectors 126a˜126b is disposed beside the display area 112 and faces one of the light guide units 124a˜124c. Specifically, the optical detector 126a is disposed beside the display area 112 and faces the light guide unit 124a, and the optical detector 126b is disposed beside the display area 112 and faces the light guide unit 124b. The optical detector 126a senses, for example, an intensity variation of the light beam L2 emitted from the light guide unit 124a along y-direction. The optical detector 126b senses, for example, an intensity variation of the light beam L1 emitted from the light guide unit 124b along x-direction.

Furthermore, the optical touch apparatus 120 of the embodiment further includes a processing unit 130 electronically connected with the optical detector 126a or the optical detector 126b. Referring to FIG. 1 and FIG. 2, when a touch object 140 (e.g. a finger) enters the sensing space P, the processing unit 130 determines a position (x, y) of the touch object 140 relative to the display area 112 according to the intensity variations of the light beam emitted from the light guide unit corresponding to different directions.

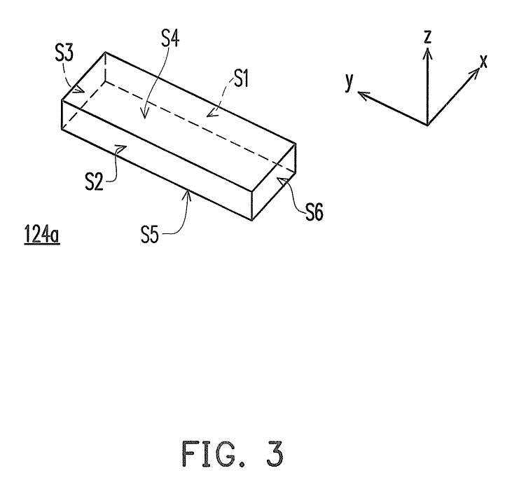

FIG. 3 is a schematic view of the light guide unit 124a of FIG. 1. As shown in FIG. 3, the light guide unit 124a has a surface S1, a surface S2, and a light incident surface S3. The surface S2 is opposite to the surface S1. The light incident surface S3 is connected with the surface S1 and the surface S2. Referring to both FIG. 1 and FIG. 3, the light beam L2 from the light source 122a enters the light guide unit 124a through the light incident surface S3 and is transmitted to the sensing space P in front of the display area 112 through the surface S1. In other words, in the embodiment, the surface S1 of the light guide unit 124a is a light emitting surface.

Moreover, the light guide unit 124a further has a surface S4, a surface S5, and a surface S6. As shown in FIG. 3, the surface S4 of the light guide unit 124a is connected with the light incident surface S3, the surface S1, and the surface S2. The surface S5 is opposite to the surface S4 and connected with the light incident surface S3, the surface S1, and the surface S2. On the other side, the surface S6 is opposite to the light incident surface S3.

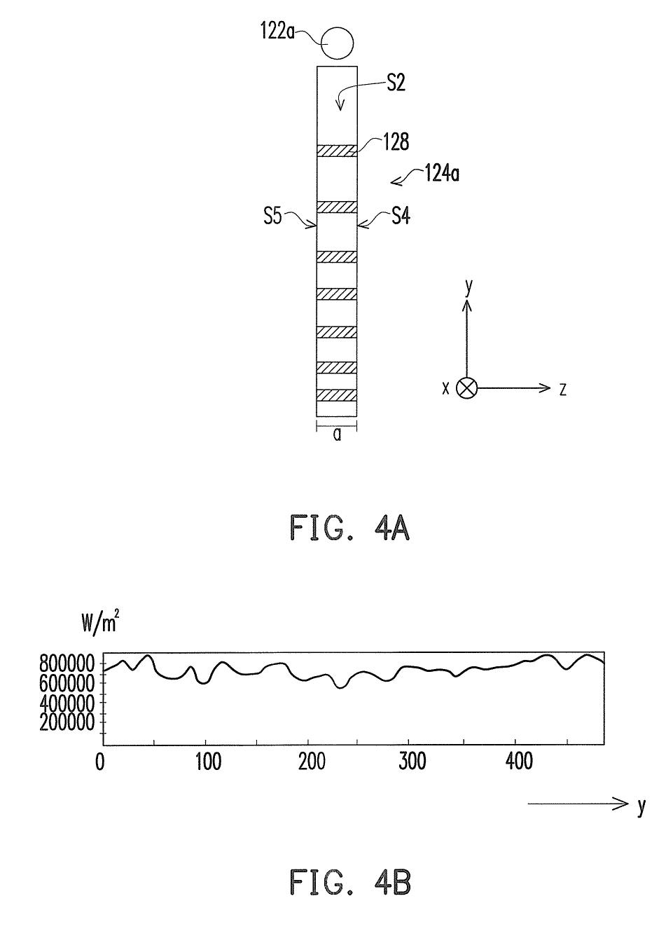

FIG. 4A is a top view of the light guide unit 124a and the light source 122a along x-direction of FIG. 3. As shown in FIG. 4A, the surface S2 has a plurality of microstructures 128. A number density of the microstructures 128 close to the light source 122a is less than a number density of the microstructures 128 away from the light source 122a. Besides, the microstructures 128 are, for example, printing dots or etching dots. The printing dots are, for example, protrusions or protruding patterns. The etching dots are, for example, recessions or grooves. The light beam L2 at the light emitting surface (i.e. surface S1) of the light guide unit 124a is able to emit uniformly by adjusting the number density of the microstructures 128 on the surface S2, such that the light guide unit 124a is capable of providing a uniform light source along y-direction. It should be noted that, the width a of the light guide unit 124a along z-direction may be reduced so as to enhance the thinness of the optical touch apparatus 120.

FIG. 4B illustrates an irradiance distribution of the light beam L2 emitted from the light guide unit 124a in the sensing space P along y-direction. The irradiance (W/m²) is power of light irradiating on a unit area within a unit time. From FIG. 4B, the microstructures 128 of the light guide unit 124a enhance the uniformity of the irradiance of the light beam L2 along y-direction. It should be noted that, the surface S1, the surface S4, the surface S5, and the surface S6 (shown in FIG. 3) may have the above-mentioned microstructures 128 in another embodiment. In other words, in another embodiment, at least one of the surface S1, the surface S2, the surface S4, the surface S5, and the surface S6 has a plurality of microstructures 128 so as to enhance the uniformity of the irradiance of the light beam L2 at the light emitting surface (i.e. surface S1) of the light guide unit 124a along y-direction. On the other hand, the light guide units 124b and 124c of FIG. 1 may have structures the same as the structure of the light guide unit 124a. Thus, the light guide units 124b and 124c may respectively provide uniform light sources at other two sides of the display area 112, such that the uniformity of the irradiance in the sensing space P is able to be enhanced as well. The structures of the light guide units 124b and 124c of the embodiment may be referred to the structure of the light guide unit 124a. Therefore, no further description is provided hereinafter.

Referring to both FIG. 1 and FIG. 3, in the embodiment, the light source 122a is disposed at a corner A of the display area 112 and the light guide unit 124a is disposed at a side 112a of the display area 112. In addition, the surface S1 faces the sensing space P. When the touch object 140 enters the sensing space P, the touch object 140 shields off a part of the light beam L2 emitted from the light guide unit 124a, such that the optical detector 126a senses an intensity variation of the light beam L2 along y-direction. In other words, the optical detector 126a senses a dark point along y-direction, such that coordinate y of a touch position is determined according to the dark point. Similarly, the touch object 140 also shields off a part of the light beam L1 emitted from the light guide unit 124b, such that the optical detector 126b senses another intensity variation of the light beam L1 along x-direction. In other words, the optical detector 126b senses a dark point along x-direction, such that coordinate x of the touch position is determined according to the dark point. Then, the processing unit 130 determines the position (x, y) of the touch object 140 relative to the display area 112 according to the intensity variations along the two directions.

It should be noted that, by properly rotating the optical detector 126b, the optical detector 126b is able to sense the intensity variation of light beam L2 emitted from the light guide unit 124a along y-direction in the sensing space P. In other words, in another embodiment, the optical detector 126a and the optical detector 126b may be able to respectively sense the intensity variations along x-direction and y-direction in the sensing space P according to their location and the direction they face. Thus, the position (x, y) of the touch object 140 is determined according to the intensity variations along different directions respectively sensed by the optical detector 126a and the optical detector 126b. In other words, the locations of the optical detector 126a and the optical detector 126b are not limited to the locations as shown in FIG. 1, and may be varied by request.

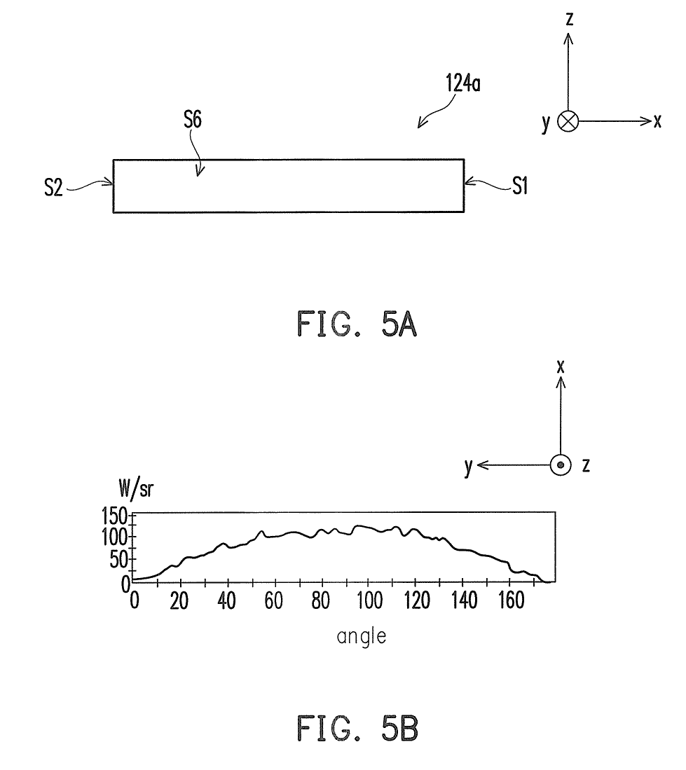

FIG. 5A is a top view of the surface S6 of the light guide unit 124a in FIG. 3. FIG. 5B illustrates a distribution of radiant intensity versus light emitting angle when the light beam L2 is emitted from the surface S1 of the light guide unit 124a of FIG. 3. Referring to both FIG. 1 and FIG. 5B, as shown in FIG. 5B, in an embodiment, when a light emitting angle of the light beam L2 is 90° (i.e. the light beam L2 is emitted along positive x-direction), the radiant intensity (W/sr) is 130 W/sr approximately. Specifically, light emitting angles 80° and 100° of FIG. 5B represent that the light beam L2 is emitted from the surface S1 at an angle of 10° relative to positive x-direction. On the other hand, light emitting angles 60° and 120° of FIG. 5B represent that the light beam L2 is emitted from the surface S1 at an angle of 30° relative to positive x-direction. As shown in FIG. 5B, the radiant intensity of the light beam L2 in the sensing space P decreases as the angle between a light transmission path and positive x-direction increases.

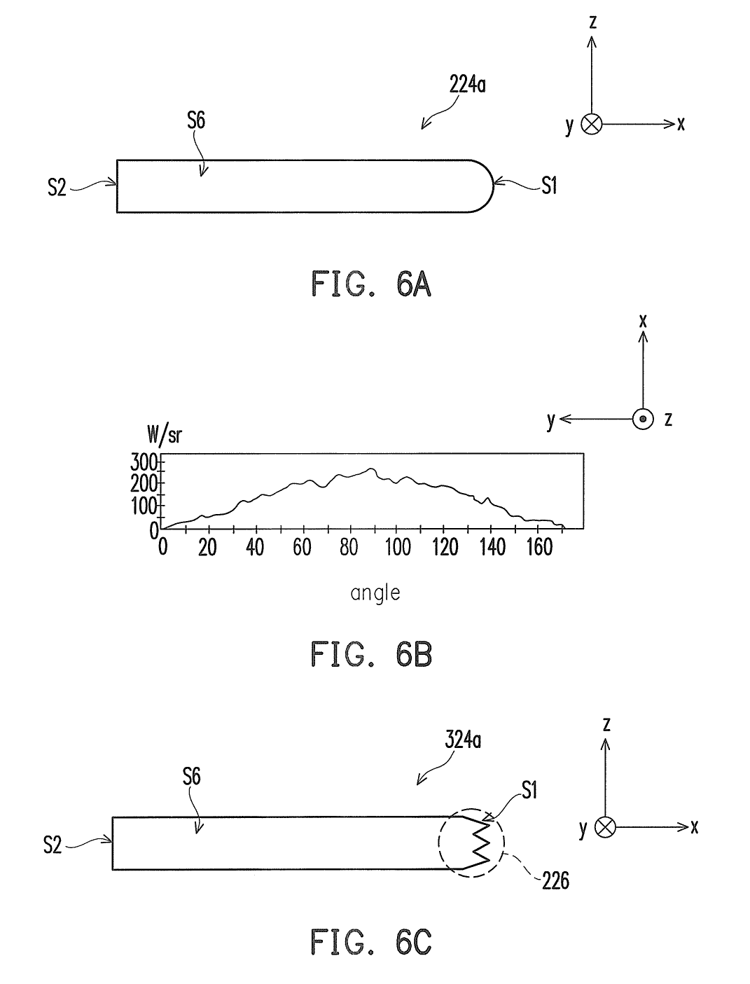

FIG. 6A is a top view of a surface S6 of a light guide unit 224a in another embodiment of the invention. The light guide unit 224a is similar to the light guide unit 124a of FIG. 5A, while the major difference lies in that the surface S1 is a convex surface. The function of the convex surface is similar to the function of a lens. That is, the convex surface is able to concentrate a light emitting angle of a light beam, e.g. the light beam L2 of FIG. 1. FIG. 6B illustrates another distribution of radiant intensity versus light emitting angle when the light beam L2 is emitted from the surface S1 of the light guide unit 224a of FIG. 6A. As shown in FIG. 6B, in an embodiment, when a light emitting angle of the light beam L2 is 90°, the radiant intensity (W/sr) is 280 W/sr approximately, which is higher than (approximately 2 times of) the radiant intensity corresponding to the light beam L2 emitted from the surface S1 of the light guide unit 124a in FIG. 5A. In other words, compared with the light guide unit 124a of FIG. 5A, the light guide unit 224a is able to concentrate light emitting angles of the light beam L2 towards positive x-direction, such that the radiant intensity of the light beam L2 along the positive x-direction is enhanced. Besides, in another embodiment, as shown in FIG. 6C, the surface S1 of the light guide unit 324a may be a plurality of prism structures 226, the prism structures 226 are able to concentrate the light emitting angle of the light beam L2 towards positive x-direction as well.

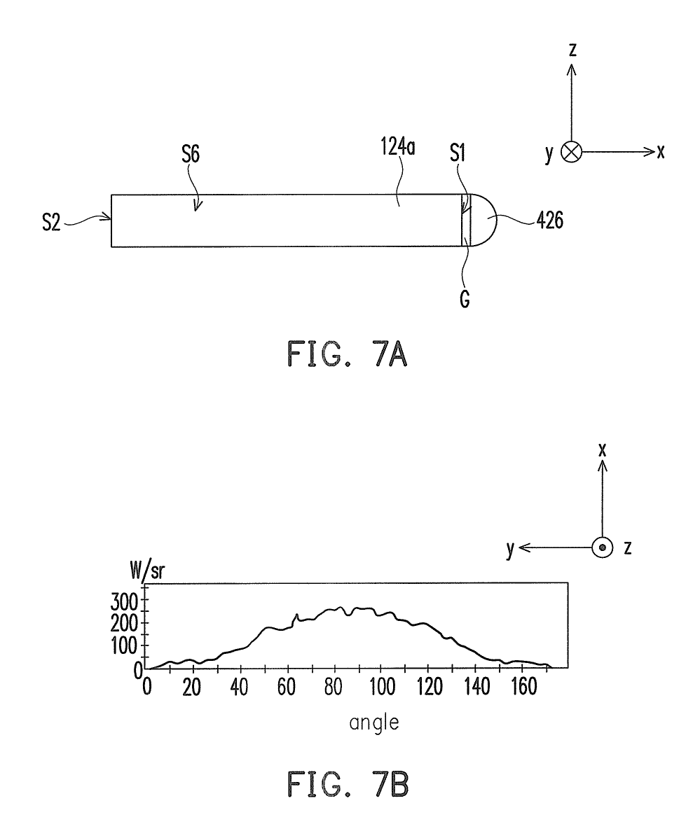

FIG. 7A is a top view of a light guide unit 124a and a lens 426 along y-direction in another embodiment of the invention. As shown in FIG. 7A, the lens 426 is further disposed on the surface S1 of the light guide unit 124a. Furthermore, an air gap G is between the lens 426 and the surface S1. Thus, the light beam L2 of FIG. 1 passes through the air gap G and is then transmitted to the lens 426 after emitted from the light emitting surface (i.e. surface S1). FIG. 7B illustrates a distribution of radiant intensity versus light emitting angle when the light beam L2 passes through the light guide unit 124a, the air gap G, and the lens 426. As shown in FIG. 7B, in an embodiment, when a light emitting angle of the light beam L2 is 90°, the radiant intensity is about 320 W/sr, which is higher than the radiant intensity (280 W/sr) corresponding to the light beam L2 emitted from the surface S1 of the light guide unit 224a in FIG. 6A.

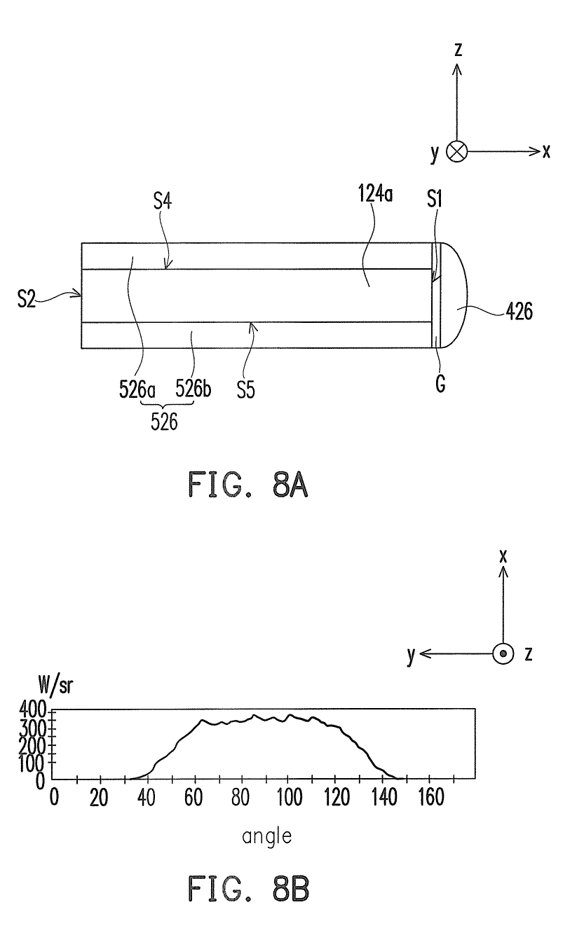

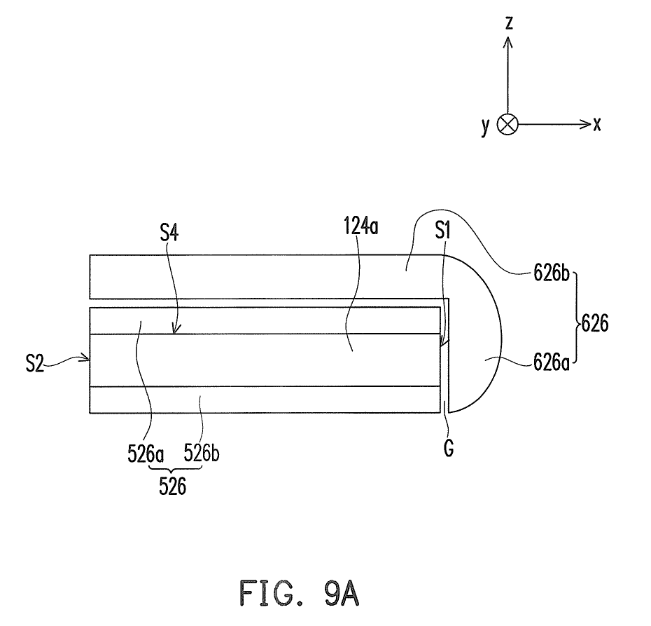

FIG. 8A is a top view of the light guide unit 124a, the lens 426, and a reflective unit 526 along y-direction in another embodiment of the invention. As shown in FIG. 8A, the reflective unit 526 is further disposed on the light guide unit 124a. The reflective unit 526 is disposed on at least one of the surfaces S4 and S5, such that leakages of the light beam L2 (shown in FIG. 1) from the surface S4 and the surface S5 are reduced.

In the embodiment, the reflective unit 526 includes, for example, two reflective sheets 526a and 526b, and the reflective sheets 526a and 526b are respectively disposed on the surface S4 and the surface S5. It should be noted that, the reflective unit 526 may be disposed on the surface S2 and the surface S6 (shown in FIG. 3) of the light guide unit 124a in another embodiment. In other words, the reflective unit 526 is disposed on at least one of the surface S2, the surface S4, the surface S5, and the surface 6. That is to say, all surfaces of the light guide unit 124a may be covered with the reflective unit 526 except the light incident surface S3 and the light emitting surface (i.e. surface S1). The reflective unit 526 is, for example, a white reflective sheet, an aluminum reflective sheet, an aluminum film, or a sliver film.

Besides, the lens 426 of FIG. 8A is not only disposed on the surface S1 but also disposed beside the reflective sheets 526a and 526b. Moreover, the air gap G is between the lens 426 and the surface S1. Referring to both FIG. 1 and FIG. 8A, the light beam L2 from the light source 122a is reflected several times between the two reflective sheets 526a and 526b and then emitted from the light emitting surface (i.e. surface S1) in a proper light emitting angle. Then, the light beam L2 passes through the air gap G first and then is transmitted to the lens 426. Since the reflective sheets 526a and 526b are respectively disposed on the upper surface S4 and the bottom surface S5, the power of the light beam L2 emitted from the light emitting surface (i.e. surface S1) is enhanced.

FIG. 8B illustrates another distribution of radiant intensity versus light emitting angle when the light beam L2 passes through the light guide unit 124a, the air gap G, and the lens 426. As shown in FIG. 8B, in an embodiment, when a light emitting angle of the light beam L2 is 90°, the radiant intensity is 360 W/sr approximately, which is higher than the radiant intensity (320 W/sr) corresponding to the light beam L2 emitted from the surface S1 of the light guide unit 124a in FIG. 7B. In other words, by using the light guide unit 124a together with the reflective unit 526, the radiant intensity of light beam L2 along positive x-direction is enhanced.

It should be noted that, the figures from optical experiments shown in FIG. 4B, FIG. 5B, FIG. 6B, FIG. 7B, and FIG. 8B are not used to limited the invention. One of ordinary skill in the art may modify data to obtain different figures from optical experiments after referring to the invention without departing from the scope of the invention. Those modifications still fall within the scope of the invention.

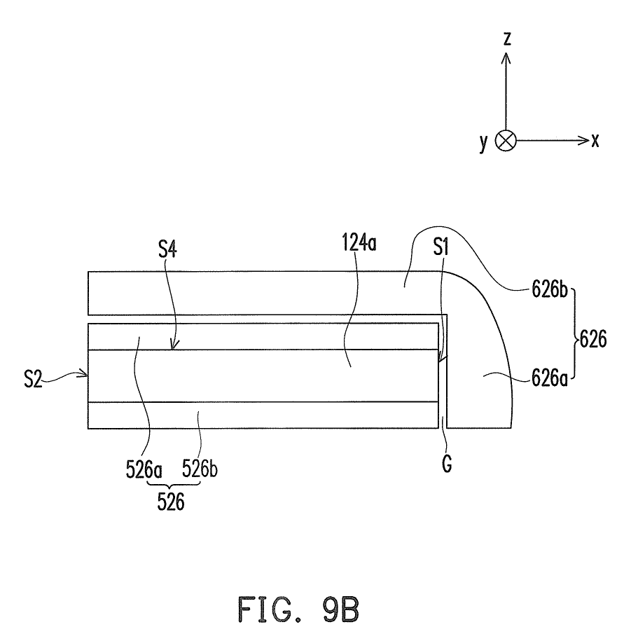

FIG. 9A is a top view of the light guide unit 124a, the reflective unit 526, and a front frame 626 along y-direction in another embodiment of the invention. As shown in FIG. 9A, the front frame 626 is further disposed on the light guide unit 124a. The front frame 626 includes a lens portion 626a and a cover portion 626b. The cover portion 626b covers the surface S4. The lens portion 626a is formed with the cover portion 626b integrally and disposed on the surface S1.

The function of the lens portion 626a of the front frame 626 is the same as the function of the lens 426. Namely, the lens portion 626a is able to concentrate the light emitting angle of the light beam L2 from the surface S1 towards positive x-direction. The cover portion 626b has a function for protection. Besides, a color master may be added into the front frame 626, for example. Thus, the artistry-featuring look of the optical touch display apparatus is enhanced. Furthermore, an infrared ray is able to pass through the color master. That is to say, the light beam L2 is capable of passing through the lens portion 626a to the sensing space P, such that the sensing function of the optical detectors 126a and 126b are not affected.

As shown in FIG. 9A, the reflective unit 526 of FIG. 8A is further disposed on the light guide unit 124a of the embodiment, such that the power of the light beam L2 emitted from the light emitting surface (i.e. surface S1) is enhanced. In other words, the front frame 626 of the embodiment covers the light guide unit 124a and the reflective unit 526. However, in another embodiment, the reflective unit 526 may not be disposed on the light guide unit 124a. That is, the front frame 626 may be directly disposed on the light guide unit 124a.

FIG. 9B is a top view of the light guide unit 124a, the reflective unit 526, and the front frame 626 along y-direction in another embodiment of the invention. FIG. 9A and FIG. 9B are similar, but the major difference of them lies in the shape of the lens portion 626a of the front frame 626. It should be noted that the shape of the lens portion 626a of the front frame 626 may be designed according to the actual requirements. FIG. 9A and FIG. 9B are only used for reference, and not intended to limit the invention.

In Summary, the embodiment or embodiments of the invention may have at least one of the following advantages: the optical touch apparatus and the optical touch display apparatus determine the positions of the touch objects by using the optical detectors for sensing the intensity variations of the light beams. Since each light guide unit according to the embodiments of the invention provides an uniform light source, the number of the light sources and optical detectors disposed beside the display area are able to be reduced, the light guide unit not only reduces the fabricating cost but also is advantageous to a variation in dimension of the apparatus. Besides, because no complicated components and process are required in the fabrication of the optical touch apparatuses of the embodiments, the fabricating cost thereof is far lower than the fabricating cost of the resistance or capacitance touch apparatus. Furthermore, the ultra-thin light guide unit also enhances the thinness of the optical touch apparatus.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An optical touch apparatus adapted to a display apparatus having a display area, the optical touch apparatus comprising:
at least one light source disposed beside the display area and capable of providing a light beam; at least one light guide unit disposed beside the display area in a transmission path of the light beam, the light guide unit comprising:
a first surface;
a second surface opposite to the first surface; and
a light incident surface connected with the first surface and the second surface, wherein the light beam is capable of entering the light guide unit through the light incident surface and being transmitted to a sensing space in front of the display area through the first surface; and
at least one optical detector disposed beside the display area to sense an intensity variation of the light beam in the sensing space.

2. The optical touch apparatus of claim 1, further comprising a processing unit electronically connected with the optical detector, wherein the processing unit determines a position of the touch object relative to the display area according to the intensity variation when a touch object enters the sensing space.

3. The optical touch apparatus of claim 1, wherein the light guide unit further has:
a third surface connected with the light incident surface, the first surface, and the second surface;
a fourth surface opposite to the third surface, wherein the fourth surface is connected with the light incident surface, the first surface, and the second surface; and
a fifth surface opposite to the light incident surface, wherein at least one of the first surface, the second surface, the third surface, the fourth surface, and the fifth surface has a plurality of microstructures, and a number density of the microstructures close to the light source is less than a number density of the microstructures away from the light source.

4. The optical touch apparatus of claim 3, further comprising a reflective unit disposed on at least one of the second surface, the third surface, the fourth surface, and the fifth surface.

5. The optical touch apparatus of claim 1, wherein the first surface is a convex surface.

6. The optical touch apparatus of claim 1, wherein the first surface has a plurality of prism structures.

7. The optical touch apparatus of claim 1, further comprising a lens disposed on the first surface.

8. The optical touch apparatus of claim 3, further comprising a front frame, the front frame comprising:
a cover portion covering the third surface; and
a lens portion formed with the cover portion integrally, wherein the lens portion is disposed on the first surface.

9. The optical touch apparatus of claim 1, wherein the optical detector is disposed at a side of the display area and faces the light guide unit.

10. The optical touch apparatus of claim 1, wherein the at least one light guide unit comprises a plurality of light guide units, the at least one light source comprises a plurality of light sources, and the light guide units and the corresponding light sources are disposed at different sides of the display area, respectively.

11. The optical touch apparatus of claim 10, wherein the at least one optical detector comprises a plurality of optical detectors, and each of the optical detectors is disposed beside the display area and faces one of the light guide units.

12. The optical touch apparatus of claim 1, wherein the light source is disposed at a corner of the display area, the light guide unit is disposed at a side of the display area, and the first surface faces the sensing space.

13. An optical touch display apparatus, comprising:
a display apparatus having a display area; and
an optical touch apparatus comprising:
at least one light source disposed beside the display area and capable of providing a light beam;
at least one light guide unit disposed beside the display area in a transmission path of the light beam, the light guide unit having:
a first surface;
a second surface opposite to the first surface; and
a light incident surface connected with the first surface and the second surface, wherein the light beam is capable of entering the light guide unit through the light incident surface and being transmitted to a sensing space in front of the display area through the first surface; and
at least one optical detector disposed beside the display area to sense an intensity variation of the light beam in the sensing space.

14. The optical touch display apparatus of claim 13, further comprising a processing unit electronically connected with the optical detector, wherein the processing unit determines a position of the touch object relative to the display area according to the intensity variation when a touch object enters the sensing space.

15. The optical touch display apparatus of claim 13, wherein the light guide unit further has:
a third surface connected with the light incident surface, the first surface, and the second surface;
a fourth surface opposite to the third surface, wherein the fourth surface is connected with the light incident surface, the first surface, and the second surface; and
a fifth surface opposite to the light incident surface, wherein at least one of the first surface, the second surface, the third surface, the fourth surface, and the fifth surface has a plurality of microstructures, and a number density of the microstructures close to the light source is less than a number density of the microstructures away from the light source.

16. The optical touch display apparatus of claim 15, further comprising a reflective unit disposed on at least one of the second surface, the third surface, the fourth surface, and the fifth surface.

17. The optical touch display apparatus of claim 13, wherein the first surface is a convex surface.

18. The optical touch display apparatus of claim 13, wherein the first surface has a plurality of prism structures.

19. The optical touch display apparatus of claim 13 further comprising a lens disposed on the first surface.

20. The optical touch apparatus of claim 15 further comprising a front frame, the front frame comprising:
a cover portion covering the third surface; and
a lens portion formed with the cover portion integrally, wherein the lens portion is disposed on the first surface.

21. The optical touch display apparatus of claim 13, wherein the optical detector is disposed at a side of the display area and faces the light guide unit.

22. The optical touch apparatus of claim 13, wherein the at least one light guide unit comprises a plurality of light guide units, the at least one light source comprises a plurality of light sources, and the light guide units and the corresponding light sources are disposed at different sides of the display area respectively.

23. The optical touch display apparatus of claim 22, wherein the at least one optical detector comprises a plurality of optical detectors, and each of the optical detectors is disposed beside the display area and faces one of the light guide units.

24. The optical touch apparatus of claim 13, wherein the light source is disposed at a corner of the display area, the light guide unit is disposed at a side of the display area, and the first surface faces the sensing space.
